(19) United States
(12) Patent Application Publication
(10) Pub. No.: US 2003/0220592 A1
(43) Pub. Date: Nov. 27, 2003

(54) Apparatus and method for producing bipolar acoustic pulses

(75) Inventor: Harald Eizenhofer, Seefeld (DE)

Correspondence Address: KING & SPALDING, 191 PEACHTREE STREET, N.E., ATLANTA, GA, 30303-1763, US

(73) Assignee: Dornier MedTech Systems GmbH, Wessling (DE)

(21) Appl. No.: 10/392,334

(22) Filed: Mar. 18, 2003

(30) Foreign Application Priority Data
Mar. 18, 2002 (DE) 102-11-886.8

(51) Int. Cl. A61H 1/00

(52) U.S. Cl. 601/2

(57) ABSTRACT

An apparatus and method for producing bipolar acoustic pulses is provided. The apparatus includes a boundary layer medium in between a propagation medium and a border medium. The boundary layer medium is configured to reflect unipolar acoustic pulses to convert them into bipolar acoustic pulses. The method includes providing the foregoing boundary layer medium, propagation medium, and border medium, and additionally providing a reflector positioned to reflect unipolar acoustic pulses onto the boundary layer medium. The method further includes converting unipolar acoustic pulses into bipolar acoustic pulses by reflecting the unipolar acoustic pulses off of the boundary layer medium.

### CROSS REFERENCE TO RELATED APPLICATION

This application claims priority to co-pending German patent application No. 102 11 868.8, which was filed on Mar. 18, 2002.

### FIELD OF THE INVENTION

The invention generally relates to the application of acoustic energy pulses to living tissue, and more particularly, to producing bipolar acoustic pulses from unipolar acoustic pulses.

### BACKGROUND OF THE INVENTION

The application of acoustic shock wave sources in modern medical technology includes the manipulation of active chemical or biological substances, for example to facilitate cell transfection or the activation of such active substances through molecular breakdown. Such applications of shock wave sources are used to generate so-called cavitation bubbles within the substances they are applied to, so the applications can be referred to as the generation of cavitation. An electromagnetic shock wave emitter (EMSE) is an example of a shock wave source, and an EMSE typically includes a surface-type coil and a conducting membrane. The EMSE can produce an almost pure pressure pulse, since the electromagnetic forces acting between the coil and the membrane typically act repulsively.

N-waves are a configuration of acoustic waves or pulses that can be produced by an acoustic shock wave source, such as an EMSE. Outside the area of cavitation, N-waves are also associated with the production of sonic booms, for example, by the operation of supersonic aircraft. N-waves typically exhibit the shape of a letter “N” over one period of a wave, and inverse N-waves typically exhibit the shape of an upside down letter “N” over one period of a wave. Thus, an inverse N-wave may be characterized by a negative portion of a saw tooth-type, bipolar acoustic wave followed by a positive portion of the wave.

Application of inverse N-waves can be useful where a pulsed, efficient generation of cavitation is needed, for example in medical surgery, biotechnology, or gene-technology applications. One advantage of using inverse N-waves to generate cavitation is that inverse N-waves typically form cavitation bubbles that expand and then violently collapse at a focal point of the inverse N-waves. This generation of cavitation forms highly energetic microjets in the substance that are beneficial to accomplish manipulations in the substance, such as described above.

Existing sources of shock waves for the generation of cavitation typically employ a plane of piezoelectric sound sources and a reflector that reflects emitted waves to a focus point, for example in an active substance. However, such existing shock wave sources are typically not able to produce inverse N-waves because of the limitations of configuring the components of the these existing sources. For example, DD Patent Specification No. 7108, dated Jan. 13, 1953, discloses a typical geometry of a therapy head device in the form of a so-called ultrasonic concentrator. This device consists of a plane of piezoelectric sound sources and a parabolic reflector which reflects the emitted wave to the generating sound source which runs to a focus point. The ultrasonic concentrator operates with continuous, infinitely long sinusoidal wave trains that are radiated from the piezo-surface. In this respect, the phase relationship of the reflector is not significant, because the acoustically hard reflection or the acoustically soft reflection only changes the phase angle by 180°. Even with the pulsed excitation of the ultrasonic concentrator, the second reflection on the piezoelectric material typically occurs acoustically hard due to its thickness. The piezoelectric sound sources typically cannot be physically configured to generate N-waves, because the sources typically need to be configured to generate pulse durations that correspond to the thickness of the sources divided by the speed of sound.

Therefore, it should be appreciated that there is a need in the art for an invention that can produce bipolar acoustic pulses. Further, there is a need in the art for an invention that can produce bipolar acoustic pulses that can comprise inverse N-waves.

### SUMMARY OF THE INVENTION

The present invention is generally directed to an apparatus and method for producing bipolar acoustic pulses. In one aspect, the invention provides an apparatus that includes a propagation medium with a first acoustic impedance. The apparatus also includes a border medium that has a second acoustic impedance. A boundary layer medium is included between the propagation medium and the border medium that has a third acoustic impedance. The boundary layer medium is configured to convert unipolar acoustic pulses into bipolar acoustic pulses when the boundary layer medium reflects the unipolar acoustic pulses. The thickness of the boundary layer medium is less than the length of one of the unipolar acoustic pulses, and the third acoustic impedance is different from the first acoustic impedance and the second acoustic impedance

In another aspect of the present invention, a method for manipulating an acoustic pulse is provided. Broadly described, the method includes: providing a propagation medium that has a first acoustic impedance; providing a border medium that has a second acoustic impedance; providing a boundary layer medium between the propagation medium and the border medium that has a third acoustic impedance and is configured to convert unipolar acoustic pulses into bipolar acoustic pulses when the boundary layer medium reflects the unipolar acoustic pulses; providing a reflector that is positioned to reflect the unipolar acoustic pulses onto the boundary layer medium; reflecting the unipolar acoustic pulses off of the reflector onto the boundary layer medium; and, converting the unipolar acoustic pulses into the bipolar acoustic pulses by reflecting the unipolar acoustic pulses off of the boundary layer medium.

These and other aspects of the invention will be described further in the detailed description below in connection with the drawings and the claims.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 illustrates an exemplary principle for the generation of inverse N-waves in a thin boundary layer medium, in accordance with the invention.

FIG. 2 shows an exemplary boundary layer medium of an electromagnetic shock wave emitter (EMSE), in accordance with the invention.

FIG. 3a illustrates a sound wave that is reflected from an acoustically hard reflector onto the boundary layer medium introduced in FIG. 2, in accordance with the invention

FIG. 3b illustrates a trace of an exemplary inverse N-wave 15 with respect to pressure and time, in accordance with the invention.

### DETAILED DESCRIPTION OF THE INVENTION

The illustrative embodiments of the present invention will be described with reference to the drawings, wherein like elements and structures are indicated by like reference numbers.

The membrane of an EMSE (i.e., electromagnetic shock wave emitter) can represent a boundary layer in accordance with the invention. To achieve this, in an exemplary embodiment of the invention, a unipolar signal is reflected off of a reverberant reflector onto an EMSE membrane. After the first reflection off the acoustically hard reverberant reflector, the polarity of the pressure pulses of the unipolar signal is retained. After the second reflection off the generating surface of the EMSE, which is at the membrane of the EMSE, the formation of an inverse N-wave can result. In this regard, the reflecting boundary layer preferably comprises a material with a thickness that is substantially less than the signal length of the acoustic pulses in the boundary layer and an acoustic impedance that is substantially different from the acoustic impedance of the propagation medium (e.g., water) and the border medium behind the propagation medium.

FIG. 1 illustrates an exemplary principle for the generation of inverse N-waves in a thin boundary layer medium, in accordance with the invention. In this regard, FIG. 1 shows a unipolar shock wave 1, generated by a shock wave source (not shown), which propagates in a medium 4 and is reflected from a thin boundary layer medium 2 as an inverse N-wave 3. The three media involved in this reflection are a fluid 4, the boundary layer medium 2, and the border medium 5, which is typically a gas, such as air.

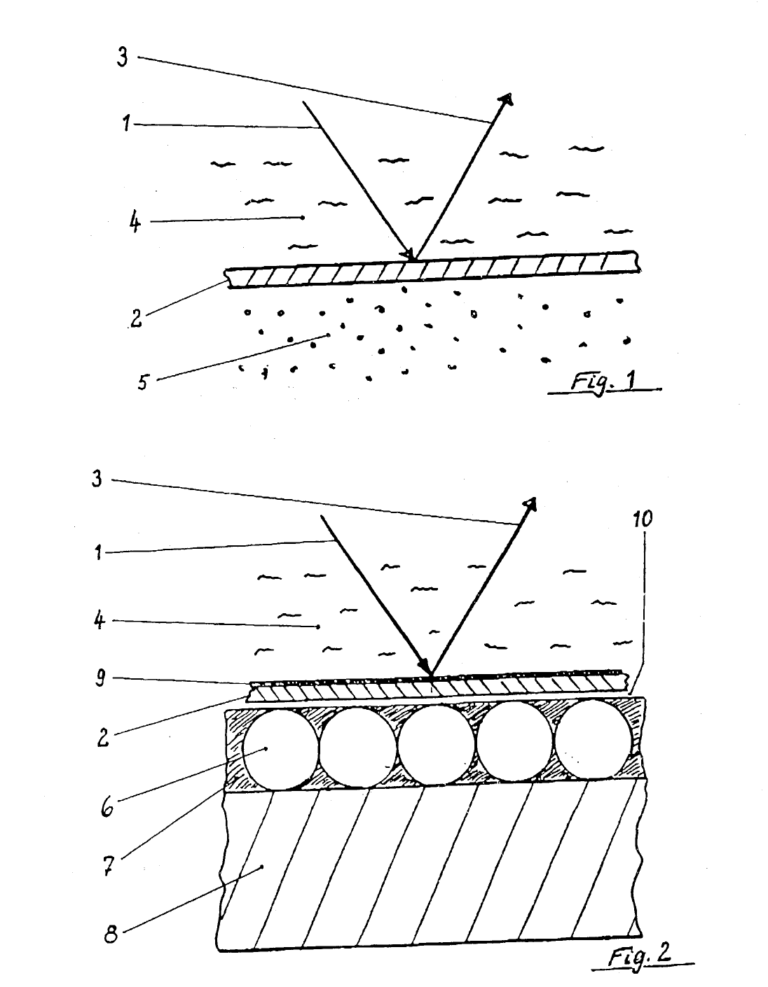

In FIG. 2, an exemplary boundary layer medium 2 of an EMSE is shown, in accordance with the invention. In this regard, the boundary layer medium 2 can be a membrane of an EMSE. The propagation medium is typically a fluid 4. A surface-type coil, which includes a coil wire 6, a coil potting compound 7, and a coil spool 8, may be located below the boundary layer medium 2, separated by an intervening space 10.

The intervening space 10 may be at least partially filled with a gas. For example, the intervening space 10 may include a thin layer of air. In some embodiments, the intervening space 10 may include a medium that is penetrated by one or more cavities (not shown). In other embodiments, the intervening space 10 may include a medium that is penetrated by fibre-type paper or porous foam material (not shown).

A thin rubber layer 9 is typically located on the boundary layer medium 2, and may preferably have a thickness of approximately 200 micrometers. A thin aluminum layer (not depicted) may also be located on the boundary layer medium in some embodiments, and may also preferably have a thickness of approximately 200 micrometers.

Focusing of the inverse N-waves, generated at the boundary layer medium 2, to a focal point F (not shown) can be accomplished, for example, using a therapy head construction in accordance with DD Patent Specification No. 7108, dated Jan. 13, 1953, which is incorporated by reference. In such an exemplary application, the construction of the piezoelectric element is preferably replaced by an EMSE with a membrane formed in accordance with the invention.

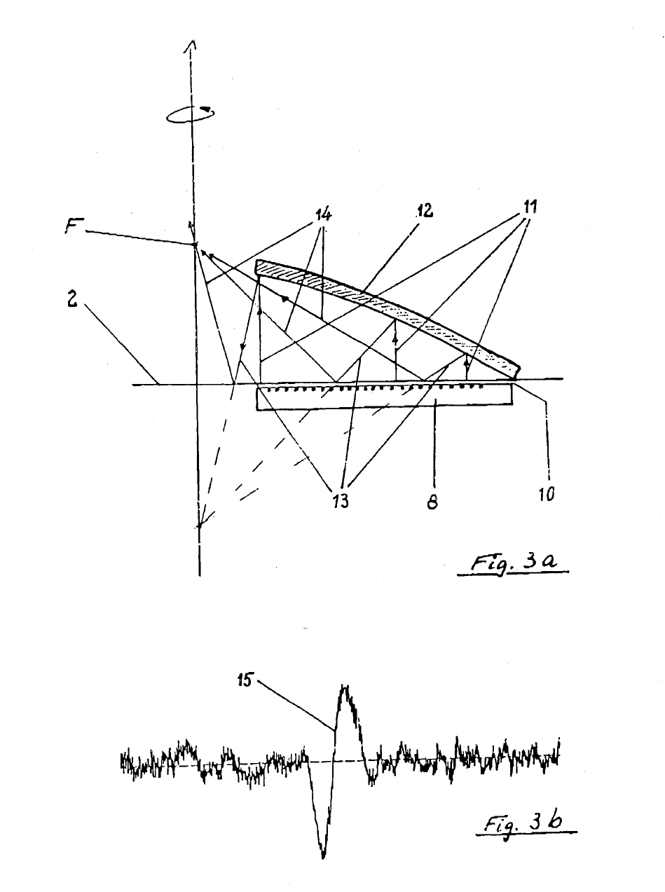

FIG. 3a illustrates a sound wave 11 that is reflected from an acoustically hard reflector 12, in the form of a reflected sound wave 13, onto the boundary layer medium 2, in accordance with the invention. In accordance with exemplary embodiments of the invention, the resulting sound wave 14 that is reflected from the boundary layer medium 2 is typically in the form of an inverse N-wave. The inverse N-wave 14 is focused toward a focal point F.

FIG. 3b illustrates a trace of an exemplary inverse N-wave 15 with respect to pressure and time, in accordance with the invention. This exemplary inverse N-wave is a typical representative of the resulting sound wave 14 discussed above with respect to FIG. 3a.

While the invention has been described with respect to the foregoing exemplary embodiments, it will be apparent to those skilled in the art that various modifications, variations and improvements of the invention may be made in light of the above teachings and within the purview of the appended claims without departing from the spirit and intended scope of the invention. In regard to the foregoing description of the exemplary embodiments of the invention, areas which are known to those of ordinary skill in the art have not been described in detail in order to facilitate a clear and concise description of the invention. Accordingly, it should be understood that the invention is not to be limited by the specific exemplary embodiments, but only by the scope of the appended claims.

What is claimed is:

1. An apparatus for producing bipolar acoustic pulses, comprising:
a propagation medium, having a first acoustic impedance;
a border medium, having a second acoustic impedance; and
a boundary layer medium between the propagation medium and the border medium, having a third acoustic impedance and configured to convert a plurality of unipolar acoustic pulses into a plurality of bipolar acoustic pulses when the boundary layer medium reflects the plurality of unipolar acoustic pulses, wherein the thickness of the boundary layer medium is less than the length of one of the plurality of unipolar acoustic pulses and the third acoustic impedance is different from the first acoustic impedance and the second acoustic impedance.

2. The apparatus of claim 1, further comprising a reflector, wherein the reflector is positioned to reflect the plurality of unipolar acoustic pulses onto the boundary layer medium and the boundary layer medium is further configured to convert the plurality of unipolar acoustic pulses into a plurality of bipolar pulses that comprise an inverse N-wave.

3. The apparatus of claim 2, wherein the reflector is further positioned to reflect the plurality of unipolar acoustic pulses so that the boundary layer medium focuses the inverse N-wave toward a focal point.

4. The apparatus of claim 1, wherein the boundary layer medium is comprised of at least two materials that are configured to have a combined thickness that is less than the length of one of the plurality of unipolar acoustic pulses.

5. The apparatus of claim 4, wherein the boundary layer medium is comprised of a layer of a rubber material and a layer of an aluminum material.

6. The apparatus of claim 5, where in the layer of the rubber material and the layer of the aluminum material are each approximately 200 micrometers in thickness.

7. The apparatus of claim 1, further comprising an intervening space between the boundary layer medium and the border medium.

8. The apparatus of claim 7, wherein the intervening space is at least partially filled with a gas.

9. The apparatus of claim 7, wherein the intervening space comprises a layer of air.

10. The apparatus of claim 7, wherein the intervening space comprises a medium material that is penetrated by at least one cavity.

11. The apparatus of claim 7, wherein the intervening space comprises a medium material that is penetrated by a material that is a fibre-type paper or a porous foam material.

12. The apparatus of claim 1, wherein the border medium is configured to operate as a source of the plurality of unipolar acoustic pulses and the boundary layer medium is further configured to operate as an acoustic membrane of the source.

13. A method for producing bipolar acoustic pulses, comprising:
providing a propagation medium, having a first acoustic impedance;
providing a border medium, having a second acoustic impedance;
providing a boundary layer medium between the propagation medium and the border medium, having a third acoustic impedance and configured to convert a plurality of unipolar acoustic pulses into a plurality of bipolar acoustic pulses when the boundary layer medium reflects the plurality of unipolar acoustic pulses, wherein the thickness of the boundary layer medium is less than the length of one of the plurality of unipolar acoustic pulses and the third acoustic impedance is different from the first acoustic impedance and the second acoustic impedance;
providing a reflector that is positioned to reflect the plurality of unipolar acoustic pulses onto the boundary layer medium;
reflecting the plurality of unipolar acoustic pulses off of the reflector onto the boundary layer medium; and
converting the plurality of unipolar acoustic pulses into the plurality of bipolar acoustic pulses by reflecting the plurality of unipolar acoustic pulses off of the boundary layer medium.

14. The method of claim 13, wherein converting the plurality of unipolar acoustic pulses comprises converting the plurality of unipolar acoustic pulses into a plurality of bipolar pulses that comprise an inverse N-wave.

15. The method of claim 14, wherein providing a reflector comprises positioning the reflector to reflect the plurality of unipolar acoustic pulses so that the boundary layer medium focuses the inverse N-wave toward a focal point.

16. The method of claim 13, further comprising providing an intervening space between the boundary layer medium and the border medium.

17. The method of claim 16, wherein providing an intervening space comprises providing an intervening space that is at least partially filled with a gas.

18. The method of claim 17, wherein providing an intervening space comprises providing an intervening space that includes a medium material that is penetrated by at least one cavity.

19. The method of claim 17, wherein providing an intervening space comprises providing an intervening space that includes a medium material that is penetrated by a material that is a fibre-type paper or a porous foam material.

20. The method of claim 13, wherein:
providing a border medium comprises providing a border medium that is configured to operate as a source of the plurality of acoustic pulses; and
providing a boundary layer medium comprises providing a boundary layer medium that is further configured to operate as an acoustic membrane of the source.
